(19) United States
(12) Patent Application Publication
(10) Pub. No.: US 2014/0054925 A1
(43) Pub. Date: Feb. 27, 2014

(54) TRUCK BODY

(71) Applicant: ESCO Corporation, Portland, OR (US)

(72) Inventors: Steven D. Hyde, Portland, OR (US); Ryan J. Kreitzberg, West Linn, OR (US)

(73) Assignee: ESCO Corporation, Portland, OR (US)

(21) Appl. No.: 13/971,661

(22) Filed: Aug. 20, 2013

Related U.S. Application Data
(60) Provisional application No. 61/691,643, filed on Aug. 21, 2012.

(51) Int. Cl. B60P 1/28

(52) U.S. Cl. CPC B60P 1/286
USPC 296/183.2

(57) ABSTRACT

A truck body with geometric features that improve material flow while the truck body is being tilted and the payload is being dumped. These geometric features influence the discharge of the material in the truck to better empty the truck body during dumping and lessen the risk or effect of carryback. The truck body geometry results in less dribble, less hang up, and less carryback. The overall discharge time is also often reduced.

### FIELD OF THE INVENTION

The present invention relates to truck bodies (also called “truck trays”), e.g., for hauling material in the mining industry. More specific aspects of this invention relate to truck bodies having improved material flow characteristic when dumping their loads and reduced carryback (i.e., material undesirably retained in the truck body after dumping).

### BACKGROUND OF THE INVENTION

Mining trucks are used in mining applications to carry material from the pit to a different location where the material is dumped. Truck bodies (or trays) are mounted to the trucks to hold the material during transit. These truck bodies are tilted upward to dump the material (see FIG. 1). Truck bodies of this type are commonly loaded using cable shovels, face shovels, hoe buckets, loaders, and the like.

In many applications, material tends to stick to the inside of the truck body when the operator tilts the truck body to dump the material. The material that remains within the truck body after it has been dumped is called “carryback” (e.g., because the truck body is not fully unloaded and this stuck material is “carried back” to the dig location with the otherwise empty truck body). This carryback problem can be exacerbated when the material being hauled has a high moisture content, oil content, and/or a high clay content. Interactions between the material being hauled and the truck body interior also can result in sticking or carryback problems.

Carryback is undesirable for several reasons. First, significant carryback reduces the capacity of the truck body for its next run or runs (which can increase the overall number of truck trips required to move the necessary material). Carryback also may form an uneven and/or sticky contact surface that may provide an origination site for adhesion of additional hauled materials on later truck runs (i.e., the amount of carryback may grow at a given origination site over time and over multiple hauls), thereby even further reducing truck body capacity. When the carryback content becomes significant enough, the truck may be temporarily taken out of service so that the carryback can be removed (which increases costs, labor, and time involved). This carryback material can be difficult to remove, and removal risks damaging the truck body, also causing the truck to be temporarily taken out of service for repairs. Moreover, any damage to the truck bed surface (e.g. from chisels, hammer, bucket teeth, etc.) can form sharp edges, corners, or other surface irregularities, which can serve as an origination site for additional carryback in the future. Carryback also leads to increased fuel cost and tire wear due to hauling unwanted material.

Mining operations have taken several steps in an effort to combat carryback. As one example, some truck operators will try to rapidly start, stop, and/or change direction of the moving truck and/or truck body while dumping in an effort to shake the material out more quickly and/or to dislodge any stuck material. This action, however, can be hard on the truck, particularly the hydraulics used to hoist the truck body and/or the structural framework of the truck.

Other countermeasures have been taken in an effort to deal with carryback problems. As another example, some mining operations have attempted to prevent or limit carryback by applying release agents and/or using special truck body liner materials. The success of release agents is contingent on mine site conditions and requires continued application. Liners can also be effective, but can significantly increase the weight of the truck body.

As another carryback countermeasure, in some truck structures, diesel exhaust from the truck engine is routed through channels defined in various areas of the truck body. The diesel exhaust heats the truck bed (which is typically made from steel), which can help cause the release of stuck on materials.

While these methods can be helpful, for some materials and/or at some mine sites, additional countermeasures are often needed to combat carryback and improve dumping performance. Accordingly, there is room in the art for improvements in the structure and construction of truck bodies to help reduce or eliminate carryback problems and/or to more efficiently empty the truck bed.

### SUMMARY OF THE INVENTION

Aspects of this invention generally relate to improvements in truck body designs that utilize, at least in part, geometry and geometric features of a truck body to manipulate material flow while the truck body is being tilted and the payload is being dumped. Aspects of this invention utilize geometric features of the truck body that influence the discharge of the material in the truck to better empty the truck body during dumping and lessen the risk or effect of carryback. The inventive geometry results in less dribble, less hang up, and less carryback. The overall discharge time is also often reduced.

Truck bodies include a front wall, two side walls and a floor to form a payload bed for receiving and hauling materials. Truck bodies (also called “truck trays”) in accordance with this invention include one or more of the following features to improve dumping of a load:
(a) a front transition surface extending between the floor and the front wall over at least a portion of their width, which in some examples have a radius of curvature of at least 500 mm, and in other examples is a surface outside of a space defined by the adjacent surfaces and an equiangular diagonal reference line with a midpoint 120 mm from the intersection of the planes of the adjacent surfaces;
(b) a corner transition surface between the front wall and an adjacent side wall over at least a portion of their heights, which in some examples has a radius of curvature of at least 300 mm, and in other examples is a surface outside of a space defined by the adjacent surfaces and an equiangular diagonal with a midpoint 120 mm from the intersection of the planes of the adjacent surfaces;
(c) a side transition surface between the floor and an adjacent side wall along at least a portion of their lengths, which in some examples has a radius of curvature of at least 300 mm, and in other examples is a surface outside of a space defined by the adjacent surfaces and an equiangular diagonal with a midpoint 120 mm from the intersection of the planes of the adjacent surfaces;
(d) a tail or rear floor portion that extends rearward and upward in relation to a front portion of the floor, which in some examples the rear floor portion extends upward from a front floor reference line defined as a rearward extension of the front floor portion and along or above a rear floor reference line that is angled to the front floor reference line within a range of about 1° to about 20°, in other examples above 10°, in other examples within a range of about 10° to about 17.5°, and in one specific example at an angle of about 15°.
(e) a curved front wall (i.e., with a radius of curvature rearward of the front wall), which in some examples has a radius of curvature of at least about 2500 mm rearward of the front wall, and in other examples has a radius of curvature within a range of about 2500 mm to about 5000 mm, in other examples within a range of about 3000 mm to about 4500 mm, and in other examples within a range of about 3500 mm to about 3950 mm.
(f) a vertical side wall taper (i.e., side walls diverging away from one another in a bottom-to-top direction) over at least a portion of their overall height, which in some examples are inclined within a range of 0° to about 10° for each wall, in other examples about 5° to about 10°, and in other examples from about 2.5° to about 7.5°; and/or
(g) an axial side wall taper (i.e., side walls diverging away from one another in a front-to-rear direction) over at least a portion of their overall lengths, which in some examples are inclined within a range of 0° to about 3°, in other examples in a range of about 1° to about 3°, in other examples less than 2°, and in other examples less than 1°.

Truck bodies having one or more of these features can exhibit improved dumping and/or reduced carryback characteristics, particularly for hauled materials having a high moisture and/or high clay content but also for hauled materials of other kinds.

Other aspects, advantages, and features of the invention will be described in more detail below and will be recognizable from the following detailed description of example structures in accordance with this invention.

### BRIEF DESCRIPTION OF THE DRAWINGS

The present invention is illustrated by way of example and is not limited in the accompanying figures, in which like reference numerals indicate the same or similar elements throughout.

FIG. 1 illustrates an example truck including a truck body in accordance with some examples of this invention.

FIG. 2A is a perspective view of an inventive truck body.

FIG. 2B is a top view of an inventive truck body.

FIG. 2C is a top view of an inventive truck body.

FIG. 2D is a side view of an inventive truck body.

FIG. 2E is a side cross section view of an inventive truck body.

FIG. 2F is a side schematic view of an inventive truck body.

FIG. 2G is a rear end view of an inventive truck body.

FIG. 3 illustrates a cross sectional view of transition surface structures between adjacent surfaces in accordance with some examples of this invention.

FIG. 4 illustrates a cross sectional view of a transition surface extending between adjacent surfaces in a space defined by the adjacent surfaces and an equiangular diagonal extending between the adjacent surfaces.

### DETAILED DESCRIPTION OF PREFERRED EMBODIMENTS

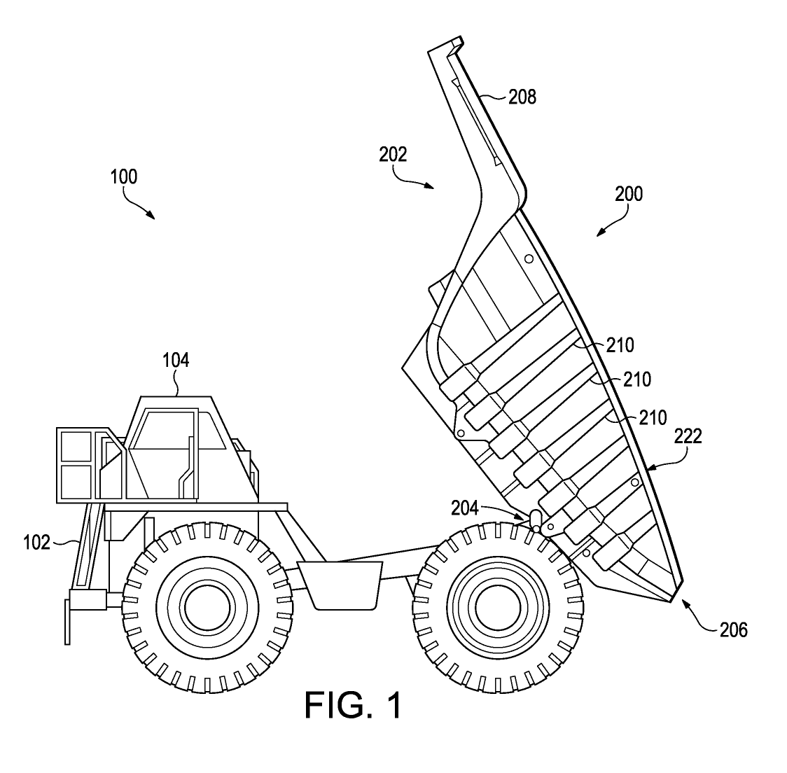

FIG. 1 illustrates a dump truck 100 including a truck body 200 in accordance with some examples of this invention. As shown in the figures, the dump truck 100 includes a truck or tractor 102 and a truck body 200 (also called a truck tray) pivotally engaged with it. The front portion 202 of the truck body 200 is pivoted upward about an axis 204 as shown in FIG. 1 (e.g., using hydraulics or other lifting or rotating mechanisms as are known and used in the art) to dump the payload out of the rear end 206 of the truck body 200. While other designs are possible, truck bodies 200 of this type typically have an open top side (providing access to the truck payload bed 212 from the top) and an open rear end. Alternatively, if desired, covers or a tailgate could be provided to at least partially cover one or more of the top or rear end 206. The front portion 202 of this example truck body 200 includes a forward extending canopy portion 208 that extends over and protects the roof of the truck cabin 104 and the truck 100, e.g., during loading of the truck body 200. The truck body 200 may be made from multiple parts, e.g., from steel or other high strength and durable materials as are conventionally known and used in the art.

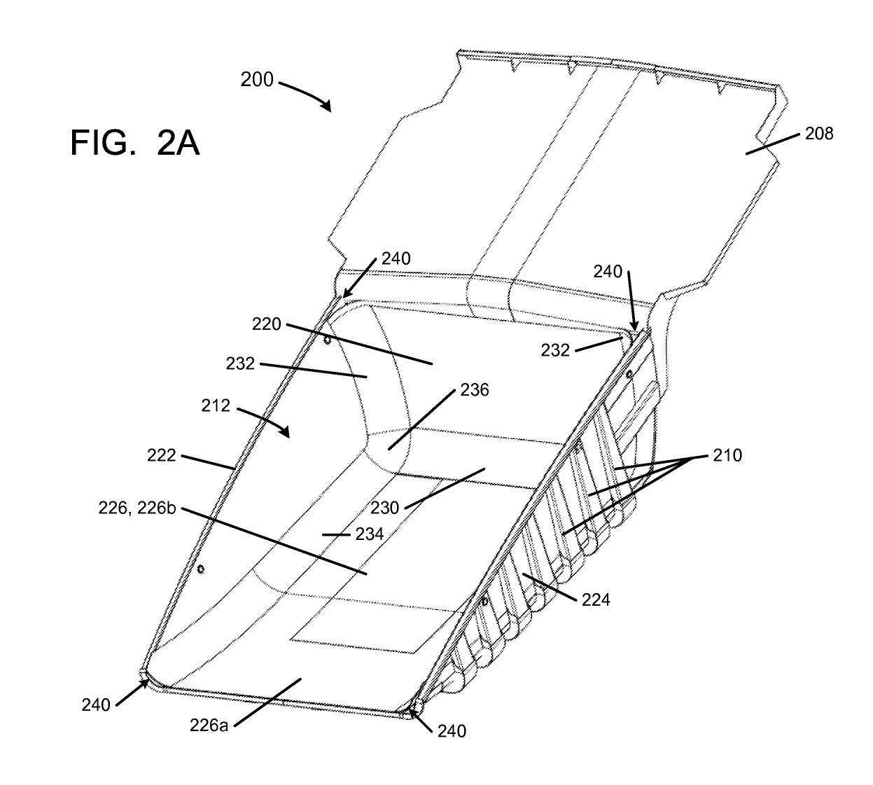

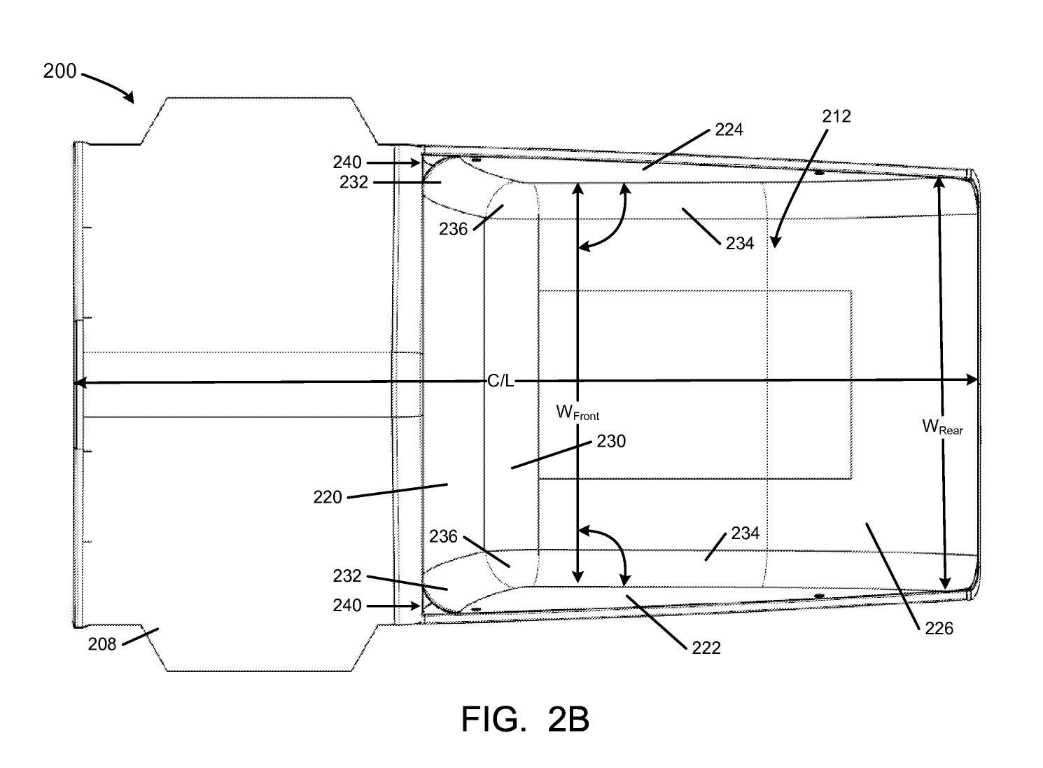

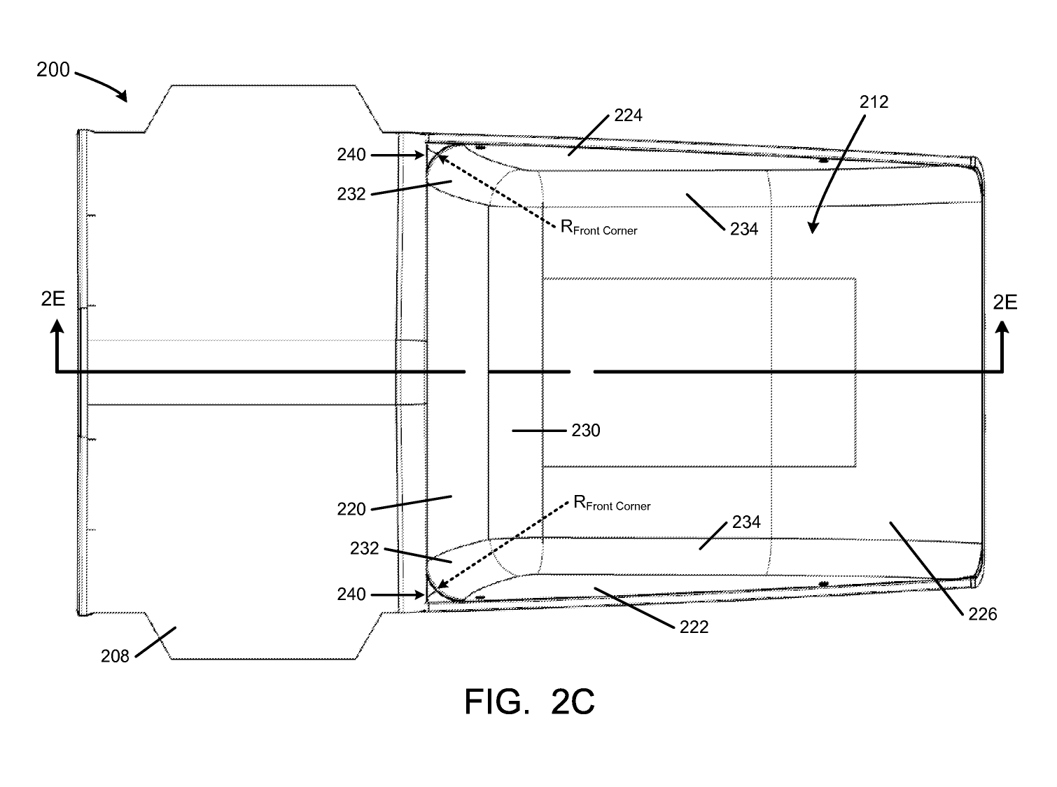

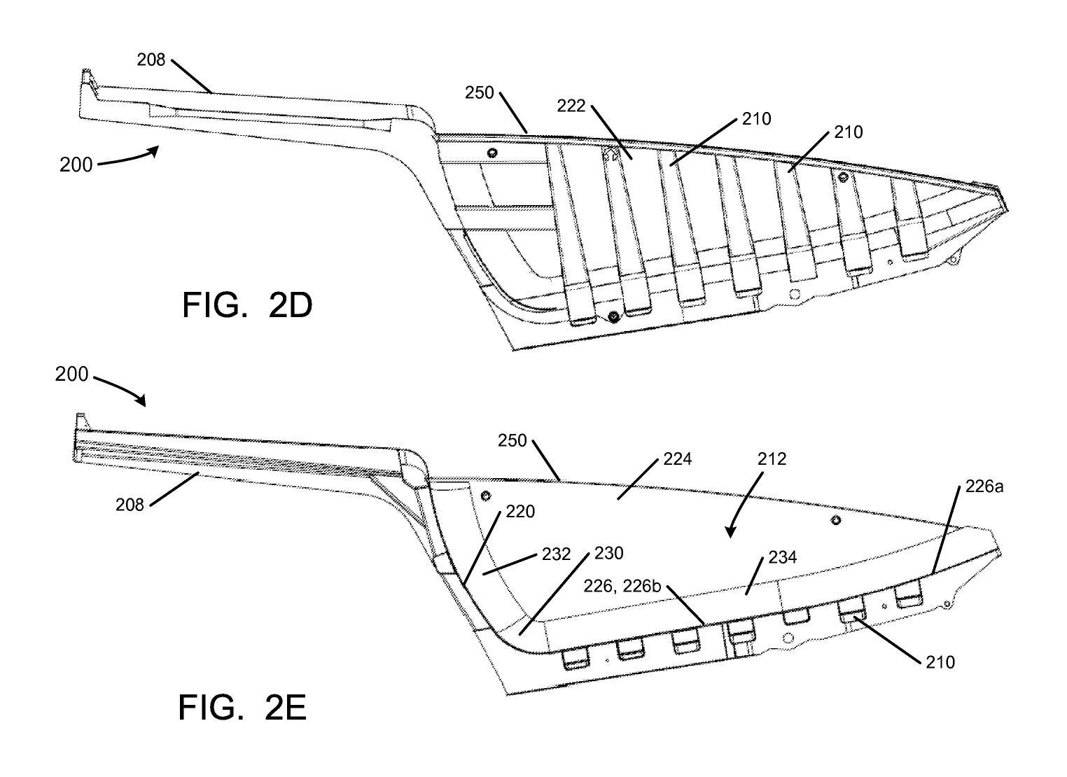

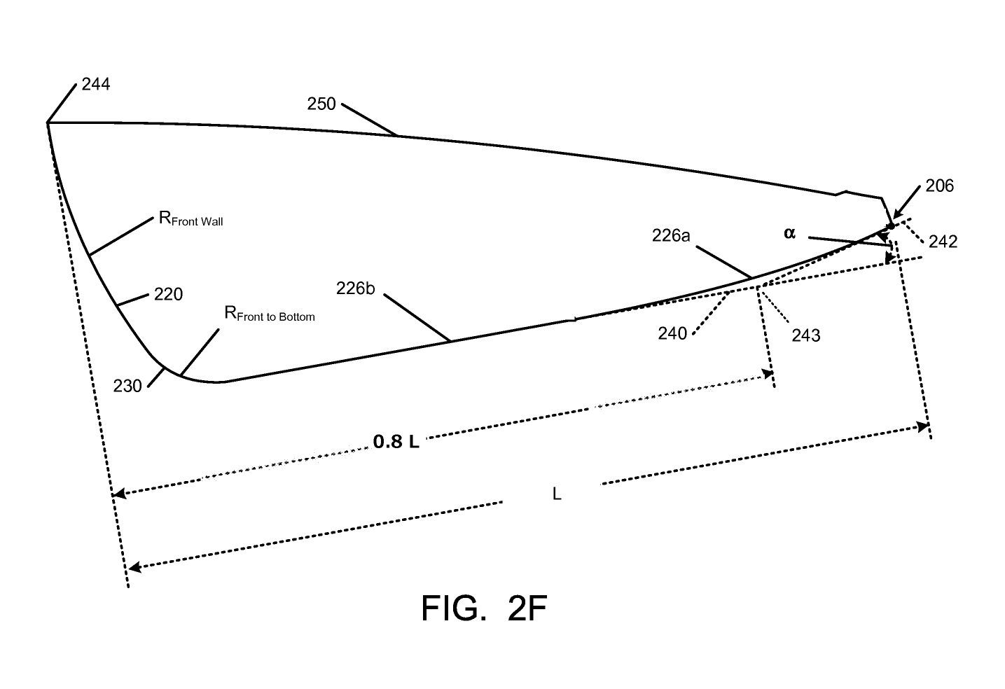

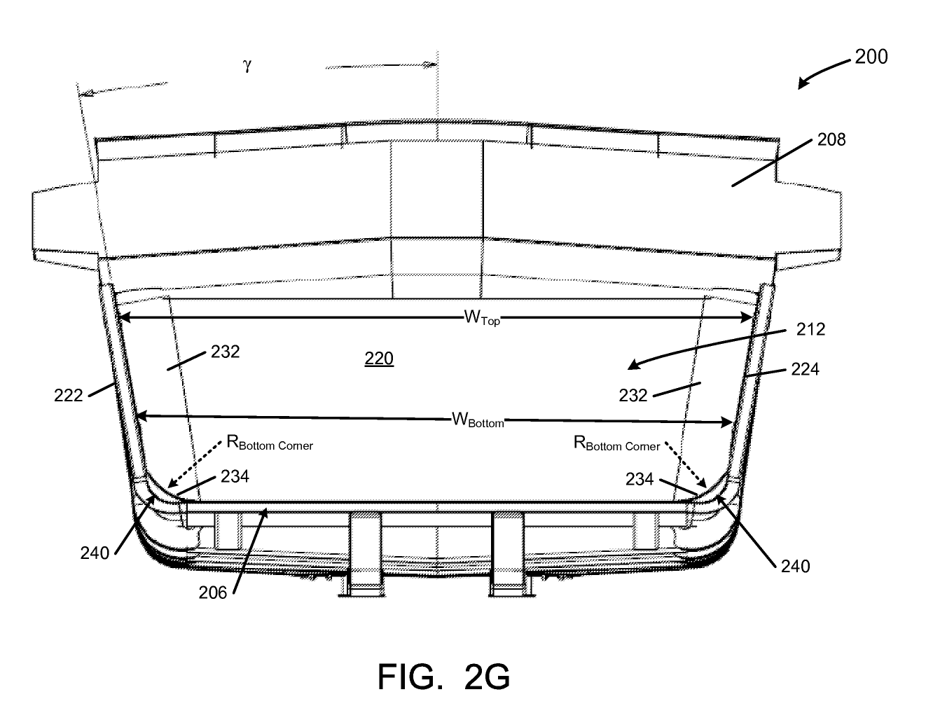

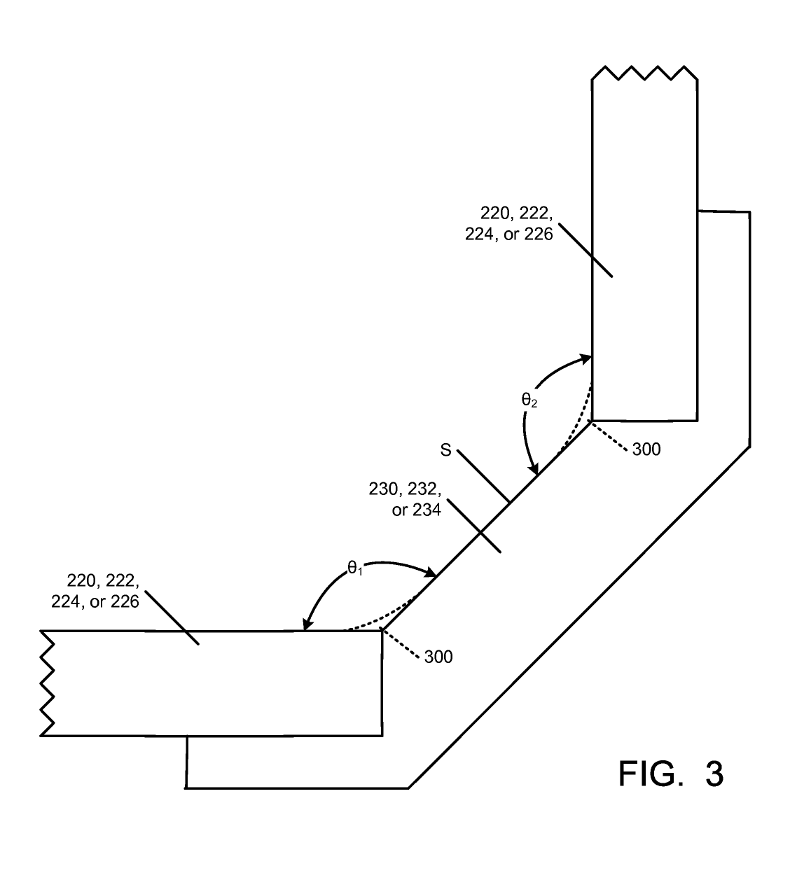

The truck body is shown in detail in FIGS. 2A-2G. The truck body 200 is shown with a “whalebone” or ribbed type construction, including a plurality of structural ribs 210 that extend around and beneath the payload bed 212 of the truck body 200, from one side to the other. While seven individual ribs 210 are shown in this example structure 200, other numbers of ribs and/or other structures may be used without departing from this invention. Additionally, one or more longitudinally (front-to-back) oriented ribs or spines may be included to provide additional strength and stiffness. The exterior structure of the truck body 200 may be similar to or have at least some features in common with the truck body structure shown in Australian Patent Application No. 2007221920 entitled “An Improved Truck Body,” published Apr. 3, 2008, which is entirely incorporated herein by reference. This “whalebone” type construction provides a strong yet relatively lightweight truck body construction, which helps reduce fuel consumption and increase payload. Truck bodies in accordance with examples of this invention may have any of the desired structural features of the truck body described in Australian Patent Application No. 2007221920.

The payload bed 212 of this example truck body 200 is defined by a headboard or front wall 220, a left side wall 222 (when facing the front), a right side wall 224 and a floor or bottom surface 226. The interior structure of the payload bed 212 of this example truck body structure 200 includes transition surfaces at various corners of these walls. More specifically, as shown in FIGS. 2A through 2G: (a) a curved transition surface 230 extends between the floor 226 and the front wall 220; (b) a curved transition surface 232 extends between the front wall 220 and each of the side walls 222 and 224; and (c) a curved transition surface 234 extends between the floor 226 and each of the side walls 222 and 224. While the various features and characteristics of the transition surfaces 232 and 234 on the right and left sides of the truck body 200 may be the same or different (and may change over their overall lengths), in this illustrated example, the transition surfaces 232 and 234 on one side of the truck body 200 mirror the corresponding surfaces 232 and 234 on the other side of the truck body 200. Additional features and potential features of these transition surfaces 230, 232, and 234 will be described in more detail below.

As mentioned above, a curved transition surface 230 extends between the front wall 220 and the floor 226 of the truck body as a front transition surface. See, for example, FIGS. 2A-2C, 2E, and 2F. While this transition surface 230 may have a wide range of curvatures in various different shapes, in some example structures in accordance with this invention, this transition surface 230 will have a radius (also called “RFront to Bottom” herein) of at least 500 mm, and in some examples, at least 600 mm. As still additional examples, this transition surface 230 may have an RFront to Bottom within a range of about 500 mm to about 1500 mm, and in some examples from about 600 mm to about 1200 mm. In this illustrated example truck body structure 200, transition surface 230 has an RFront to Bottom of about 900 mm.

In the illustrated example, the transition surface 230 between the front wall 220 and the floor 226 is curved and maintains a constant curvature over its entire length (i.e., from one interior side of the truck body 200 to the other interior side, excluding the extreme corner regions 236 described in more detail below). This is not a requirement. Rather, if desired, the curvature of the transition surface 230 may change one or more times over its length. That is, the RFront to Bottom values may vary over the length of the transition surface 230 and/or a more square corner area may be provided (e.g., in the middle area). In some example structures according to this invention, the transition surface 230 will be curved (e.g., in the manners described above) over at least 50% of its overall length, and in some examples, over at least 75% or over at least 90% of its overall length.

Another transition surface 232 extends from the side wall 222 to the front wall 220 and a corresponding curved front corner transition surface 232 extends from the side wall 224 to the front wall 220, each forming a corner transition surface. See, for example, FIGS. 2A-2C, 2E, and 2G. These front corner transition surfaces 232 may have the same or different curvature specifications without departing from this invention (and in this illustrated example, they have the same curvature specifications), and they may have a wide range of curvatures. In some example structures according to this invention, each front corner transition surface 232 will have a radius of curvature (“RFront Corner”) of at least 300 mm, and in some examples, at least 600 mm. As some more specific examples, RFront Corner may be from about 550 mm to about 1500 mm or even from about 600 mm to about 1000 mm. In this illustrated example truck body 200, each front corner transition surface 232 has an RFront Corner of about 600 mm.

In the illustrated example, the front corner transition surfaces 232 between the front wall 220 and the side walls 222 and 224 are curved and maintain constant curvatures over their entire heights (i.e., from the top of the truck body 200 to the bottom of the truck body 200, excluding the extreme corner regions 236 described in more detail below). This is not a requirement. Rather, if desired, the curvatures of the transition surfaces 232 may change one or more times over their overall heights and/or one or more square corner areas may be provided. In some example structures according to this invention, the transition surfaces 232 will be curved over at least 50% of their overall heights, and in some examples, over at least 75% or over at least 90% of their overall heights. If a more “square corner” area is provided at the junction between the front wall 220 and the side walls 222 and/or 224, preferably this area is located closer to the top rail 250 of the truck body 200 than toward the floor 226.

A curved transition surface 234 extends from the side wall 222 to the floor 226, and a corresponding curved transition surface 234 extends from the side wall 224 to the floor 226, each as a side transition surface. See, for example, FIGS. 2A-2C and 2E. These bottom corner transition surfaces 234 may have the same or different curvature specifications without departing from this invention (and in this illustrated example, they have the same curvature specifications), and they may have a wide range of curvatures. In some example structures according to this invention, each bottom corner transition surface 234 will have a radius of curvature (“RBottom Corner”) of at least 300 mm, and in some examples, at least 600 mm. As some more specific examples, RBottom Corner may be from about 550 mm to about 1500 mm or even from about 600 mm to about 1000 mm. In this illustrated example truck body 200, each bottom corner transition surface 234 has an RBottom Corner of about 600 mm.

In the illustrated example, the bottom corner transition surfaces 234 between the floor 226 and the side walls 222 and 224 are curved and maintain constant curvatures over their entire lengths (i.e., from the front of the truck body 200 to the rear of the truck body 200, excluding the extreme corner regions 236 described in more detail below). This is not a requirement. Rather, if desired, the curvatures of the transition surfaces 234 may change one or more times over their overall lengths (e.g., having different RBottom Corner values at different areas) and/or one or more square corner areas may be provided. In some example structures according to this invention, the transition surfaces 234 will be curved in the manners described above over at least 50% of their overall lengths, and in some examples, over at least 75% or over at least 90% of their overall lengths. If a more “square corner” area is provided at the junction between the floor 226 and the side walls 222 and/or 224, preferably this area is located closer to the rear of the truck body 200 than toward the front of the truck body.

The various transition surfaces 230, 232, and 234 may be provided in the overall truck body structure 200 in any desired manner without departing from this invention. In some examples, the truck body walls 220, 222, 224, and 226 will be fit together in a square or relatively square manner (e.g., with square or relatively square corners), and separate, curved transition surfaces 230, 232, and/or 234 will be separately fit to the walls 220, 222, 224, and 226 (e.g., by welding, by mechanical fasteners, etc.). The weld seams (or other seams or joints) may be ground smooth and/or polished to reduce the roughness of the interior surface of the bed 212 (and thereby reduce the likelihood of the seam or joint forming an origination site for developing carryback). When produced in this manner, spaces 240 left between the transition surface(s) 230, 232, and/or 234 and the various walls 220, 222, 224, and/or 226 with which they are engaged may provide a channel through which diesel exhaust may be routed, if desired (e.g., for heating areas of the bed 212). Additionally or alternatively, if desired, diesel exhaust may be routed through hollow areas provided in one or more of the ribs 210. Liners with beneficial surface properties can also be added to further reduce the roughness of the interior surface of the bed 212.

As another alternative, if desired, one or more of the transition surfaces 230, 232, and/or 234 may be provided as a unitary, one-piece construction with one or more of the truck body walls 220, 222, 224, and/or 226. As yet another example, the transition surfaces 230, 232, and/or 234 may constitute structural members that join the separate wall members 220, 222, 224, and/or 226 without the adjacent surfaces meeting.

As shown in FIGS. 2A and 2B, the bottom front corner region 236 of the truck body 200 constitutes an area where the three transition surfaces 230, 232, and 234 meet in this illustrated example. If desired, this bottom front corner region 236 could be shaped to correspond to (and act as a continuation of) any one of the transition surfaces 230, 232, and/or 234. Alternatively, this bottom front corner region 236 may be shaped as a composite shape of two or more of the transition surfaces 230, 232, and 234. As yet additional examples, the bottom front corner region 236 may be shaped to substantially correspond to the interior surface of a spherical shell or a portion of a toroid. Advantageously, this bottom front corner region 236 may be shaped to avoid sharp corners (e.g., to provide corners having smooth surfaces and corners without right or acute angles) and to provide a smooth transition between the joined walls. This bottom front corner region 236 may be made from one or multiple parts without departing from this invention.

If desired, the bottom front corner region 236 may be one or more separate parts engaged with one or more of the various transition surfaces 230, 232, and/or 234 as the truck body interior is being constructed. Alternatively, if desired, the bottom front corner region 236 (or a portion thereof) may be integrally formed with one or more of the various transition surfaces 230, 232, and/or 234 as a unitary, one-piece construction. Advantageously, the exposed surface of the bottom front corner region 236, as well as any junction areas with other transition surfaces 230, 232, and/or 234, may be ground or polished or covered with a suitable liner to provide a smooth, exposed surface to reduce or eliminate origination sites for developing carryback.

Other advantageous geometric features of the truck body payload bed 212 surface may be provided in some example structures according to this invention. For example, if desired (and as best shown in FIGS. 2A, 2E, and 2F), the front or headboard wall 220 can be curved over at least a portion of its height and/or across at least a portion of the width of the front wall. The curvature is concave within the cavity of the truck body, and can be about one axis or two or more parallel axes. This curved front wall 220 can help limit carryback as it achieves a more vertical and eventually overhanging face on the upper portion of the front wall 220 as the dumping angle increases, thereby generating cleaner and faster material release from the front wall during dumping. Additionally, the curvature can help improve the overall stiffness and strength of the truck body 200, limiting or reducing impact damage, which is advantageous when material is loaded into the payload bed 212. The curved front wall 220 also increases the overall payload volume of the truck bed 212 (as compared to a vertical front wall 220) without substantially affecting the truck body 200 weight.

While a range of curvatures may be used, in some truck body structures 200 according to this invention, the front wall 220 may have a radius of curvature (“RFront Wall”) of at least about 2500 mm about a horizontal axis rearward of the front wall, but in some examples having a radius of curvature within a range of about 2500 mm to about 5000 mm or even within a range of about 3000 mm to about 4500 mm. In a preferred embodiment, the front wall 220 has an RFront Wall of about 3500 mm or about 3950 mm.

As noted above, as another option or alternative, this front wall 220 may be sloped (e.g., flat or substantially flat and leaning outward with respect to the bed 212 interior). When sloped and leaning outward, the front wall 220 (when in a hauling position) may lean toward the truck front end by less than about 15° (with respect to a vertical line), and in some examples, by an angle of from about 1° to 15° or from about 2° to 10°.

In the illustrated example, the front wall 220 is curved (with a constant curvature) over its entire height (above the transition surface 230) about a horizontal axis. This is not a requirement. Rather, if desired, the front wall curvature may change one or more times over its overall height (e.g., having different RFront Wall values at different areas) and/or one or more straight or flat wall portions may be provided. In some example structures according to this invention, at least 50% of the front wall 220 will be curved, and in some examples, at least 75% or over at least 90% of the front wall will be curved. Where only a portion of the front wall is curved preferably the lower portion of the front wall is curved.

FIGS. 2A, 2E and 2F illustrate another feature that may be provided in truck bodies 200 in accordance with at least some examples of this invention. The bottom floor 226 of this illustrated example truck body structure 200 includes a forward flat bed area 226b which is substantially linear in its rearward extension. The rear portion 226a of the floor 226 extends upward above the front portion 226b. This ramped area 226a provides or contributes to various advantageous features of this example truck body 200 construction. First, because the rear portion 226a provides a more pronounced upward slant at the rear of the truck body 200 when the truck body 200 is in the downward position, the payload bed 212 of the truck body 200 has a somewhat increased capacity (as compared to a flat tail), i.e., the truck body 200 is able to retain a greater heaped load. Depending on the inclination of the rear portion 226a, the capacity of the payload bed 212 can be increased, for example, by at least 3%, and in some examples, by at least 5% or by at least 10% (as compared to a continuous flat floor). The rear portion of floor 226a can be curved, flat or a combination of shapes.

The curved or ramped area 226a also tends to hold the bulk of the material from discharging initially when the front of the truck body is raised. This initial holding of the bulk of the material causes the bed 212 to rise to a greater vertical angle before the dump begins. While this may, in many cases, result in slightly delayed initial portions of the dump sequence, the material is overall discharged from the truck body in a more laminar fashion at a higher velocity and momentum. This more laminar, faster, and more forceful movement of the discharging material (as compared to a truck bed without ramped area 226a or other features) helps sweep more of the material out of the bed 212, helps loosen stuck on material, and limits material flow dead spots, resulting in a cleaner dump, reduced material dribble, and reduced carryback. This modified discharge movement of the dumping material during the dump helps loosen and “sweep” the surfaces, especially floor 226 and front wall 220, to better clean out material and reduce carryback. In addition, the overall dump time is often reduced as compared to a conventional truck body.

The curved or ramped area 226a also tends to eject the material rearward and further away from the rear end of the truck body 200, which helps keep the dumped material away from the tires and/or mechanical structures underneath the truck body 220 (e.g., the hydraulics, braking systems, axles, differentials, and the like) and helps eject the material over berms or rills with added vertical clearance between the tail and the berms or rills in the fully dumped position. The curved or ramped area 226a also tends to increase stiffness and strength of the rear portion of the truck body 200 without adding any substantial weight to the truck body 200.

Truck bodies 200 can use any of a range of tail configurations and/or angular structures to provide inclined rear portion 226a and to produce or enhance the above advantageous effects without departing from this invention. In FIG. 2F, a floor line 240 (also called a front floor reference line) corresponds to a rearward continuation of the flat front floor surface 226b. A ramp line 242 (also called a rear floor reference line) extends upward and rearward from forward floor line 240. The rear floor portion 226a extends along or above ramp line 242.

The payload bed 212 has a length L from the front end 244 of the front wall 220 to the rear end 206 as shown in FIG. 2F. The ramp line 242 in some examples rearwardly diverges from the floor line 240 at a ramp point 243 that is located at least 6/10 of the length L of the payload bed from front end 244 and preferably more than 8/10 the length and more preferably more than 9/10 of the length L of the payload bed. The ramp line 242 can diverge from the floor line in some examples at an angle α within a range of about 1° to about 20°, in some examples more than 10°, and in some examples from about 10° to about 17.5°. In a preferred example, the ramp line has an upward angle of about 15°.

In the illustrated example, the rear portion 226a is curved or slanted upward over the entire width of the truck body 200 (e.g., from side 222 to side 224). This is not a requirement. Rather, if desired, the area 226a may change curvature or slant angle one or more times over the overall width of the truck body 200 and/or one or more straight or flat surface portions may be provided over the overall width. In some example structures according to this invention, at least 50% of the width of area 226a will be curved or slanted upward (e.g., in the manners described above), and in some examples, at least 75% or over at feast 90% of the width of area 226a will be curved or slanted.

The shape of the bottom surface or floor 226 within the curved or ramped area 226a may vary widely without departing from this invention. If desired, as shown in FIG. 2F, this area 226a may be curved somewhat, optionally with a surface thereof lying on an arc of a circle. Other curved shapes are possible without departing from the invention. As another example, if desired, the rear floor portion 226a could be flat and angled upward with respect to the flat area 226b.

This illustrated example truck body 200 includes additional geometric features on its interior surface. For example, the side walls 222 and 224 in this example truck body structure 200 taper outward with respect to a vertical angle (when the truck body 200 is oriented in a downward, load receiving condition). This angle is also called a “vertical side wall taper angle” herein. Stated another way, in this illustrated example, as best shown in FIG. 2G, the side walls 222 and 224 extend away from one another in a bottom-to-top direction (i.e., dimension WBottom<dimension WTop in FIG. 2G). While variations are possible, in some truck body structures 200 in accordance with this invention, each side wall 222, 224 will have a vertical side wall taper angle (with respect to a vertical direction with the truck body 200 in a fully downward position) within a range of 0° to about 10°, and in some examples from about 2.5° to about 7.5°.

As another potential feature, truck bodies 200 in accordance with at least some examples of this invention may include a front to back taper (e.g., the interior surfaces of the side walls 222 and 224 become spaced further apart at the truck body bottom 226 as one moves from the front of the payload bed 212 to the rear of the payload bed 212). Stated another way, and as best shown in FIG. 2B, in this illustrated example, the dimension WFront<WRear. This “front to back taper angle,” with respect to a longitudinal centerline direction C/L (see FIG. 28), may be within a range of from about 0° to about 3° (for each wall 222 and 224), and in some examples, from 0° to about 2° (for each wall 222 and 224) or from about 0° to about 1° (for each wall 222 and 224).

In the illustrated example, the side walls 222 and 224 taper outward continuously with respect to a vertical reference line over their entire lengths (e.g., the walls 222 and 224 slant outward over their entire length from front to back). These are not requirements. Rather, if desired, the vertical side wall taper angle may change over some portions of the side wall structures 222, 224, e.g., from top to bottom and/or from front to back. Advantageously, at least the bottom and front portions of the side walls will have the vertical side wall taper features described above (e.g., at least the bottom 50% and/or at least the front 50%, and in some examples, at least the bottom 75% and/or at least the front 75% or even at least the bottom 90% and/or at least the front 90%).

In the illustrated example, the side walls 222 and 224 taper outward continuously with respect to a longitudinal axis or center line C/L over their entire heights (e.g., the walls 222 and 224 slant outward toward the sides over their entire height from front to back). These are not requirements. Rather, if desired, the front to back taper angle may change over some portions of the side wall structures 222, 224, e.g., from top to bottom and/or from front to back. Also, the side walls can be parallel in a bottom-to-top direction and/or a front-to-back direction.

FIGS. 2D through 2F further illustrate that the top rail 250 (i.e., the top edge) of each side wall 222 and 224 curves generally downward from a highest point at or near the front of the payload bed 212 to a lowest point at or near the rear of the payload bed 212 (with the bed 212 in its downward position). The top rail 250 curved in this manner helps prevent contact (and any resultant damage) between the loading machinery and the side walls 222 and 224 of the truck body 200. Additionally, this feature improves loading efficiency (as the material need not be lifted as high for loading), reduces lifting requirements, and decreases loading cycle times. This top rail 250 may be curved or straight and slanted over at least a portion of its front-to-back length, e.g., in manners that are conventionally known and used in the truck body art.

In one preferred example, a truck body 200 includes a tail 226a that is along or above a ramp line 242 with an inclination of about 15°, parallel side walls, a curved side transition surface 234 between the floor and each side wall having a RBottom Corner of about 600 mm, a curved front or headboard wall 220 having an RFront Wall of about 3500 mm, a curved front transition surface 230 between the floor and the front wall having a RFront Bottom of about 900 mm, and a curved corner transition surface between the front wall and each side wall 232 having a RFront Corner of about 600 mm. A truck body having these features exhibits improved dumping and/or reduced carryback characteristics for at least some materials and/or applications.

In another preferred example, as shown in FIG. 3, the transition surfaces 230, 232, and/or 234 may be flat transition surfaces that extend at oblique angles θ with respect to the surfaces or walls 220, 222, 224, and/or 226 that they interconnect. More specifically, in some example structures according to this invention, a main, substantially flat portion of a transition surface 230, 232, and/or 234 the transition surface may form an oblique angle θ with a main, substantially flat portion of a wall 220, 222, 224, and/or 226. In the example shown in FIG. 3, θ1 is equal to θ2, and each is greater than 90°. If desired, however, θ1 may be different from θ2 (while both are still over 90°). Advantageously, if desired, θ1 and θ2 will each be equal to or greater than 120°, and in some examples, greater than 130°. In this illustrated example, θ1 and θ2 are about 135°.

In another preferred example, the transition surface 230 within the truck body will be at least 500 mm and transition surfaces 232 and 234 will be at least 300 mm. Alternatively, the transition surfaces are at least 500 mm or even at least 600 mm. If the transition surface becomes too small, a relatively tight corner may be exposed to the material to be transported, and this tight corner may support origination of carryback.

The transition surfaces join two adjacent surfaces such as a wall and the floor. Preferably, the transition surface is curved with a radius of curvature. Alternatively, the transition surface can comprise one flat surface as illustrated in FIG. 3 or may include two or more flat surfaces each at an obtuse angle to the next adjacent flat surface. Alternatively, the transition surface may be a combination of curved surfaces and flat surfaces. Curves other than arcs of a circle (i.e., radii) may be used. For example, the curved surfaces may be shaped as portions of an ellipse, oval, parabola, hyperbola, or other geometric shape. Other curved surfaces without a constant radius of curvature also are possible. Advantageously, the exposed surfaces of the transition surfaces will be smooth and/or will not include sharp corners having an acute angle exposed to the material being transported.

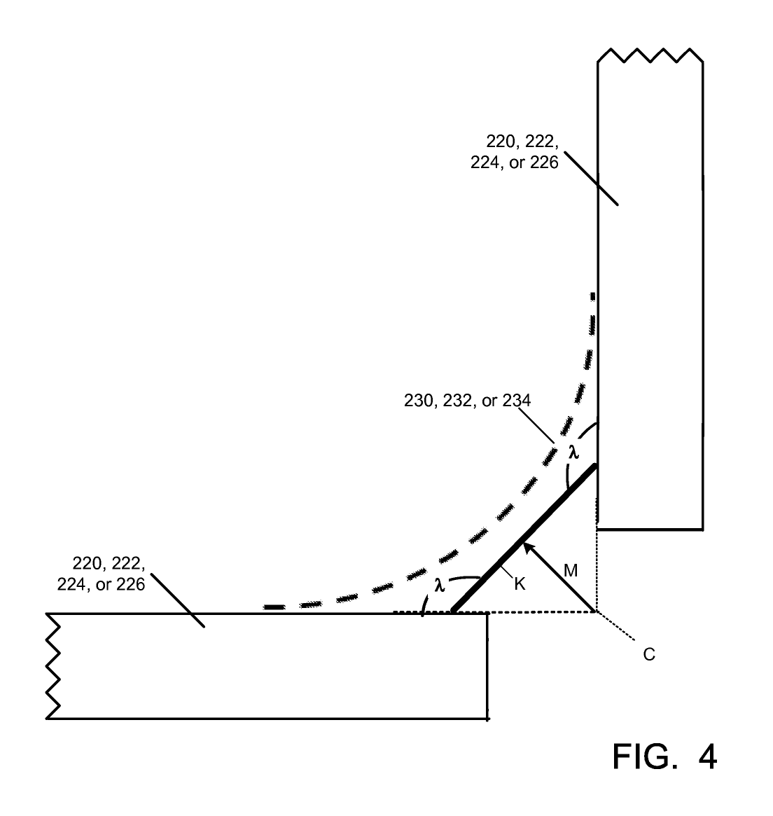

In non-circular and non-linear transition surfaces (such as in curved transition surfaces with a changing radius of curvature) the transition is still preferably sufficiently broad to lessen the risk of carryback. For example, the transition surface extends along or outside of a diagonal reference line K between the two adjacent surfaces as shown in FIG. 4. Diagonal line K extends between the adjacent surfaces such that the angles λ are equal. The planes of the surfaces meet at corner C and the midpoint of the diagonal line K is a distance M from the corner. In one preferred embodiment, the distance M is 120 millimeters.

According to these examples, the transition surface can be a wide variety of shapes that remains along or outside of the diagonal reference line K. A transition surface so defined can advantageously dump a load with minimal binding of the load in the corners. The adjacent surfaces of FIG. 4 are shown as perpendicular, but the adjacent surfaces can be at an obtuse or acute angle to each other. Where one or both of the adjacent surfaces are curved, the plane of the surfaces defining the corner C can be defined by a tangent to the curved surface at the terminating edge or preferably at the contact point of the transition surface on the one or both adjacent surfaces.

The present invention is described above and in the accompanying drawings with reference to a variety of example structures, features, elements, and combinations of structures, features, and elements. The purpose served by the disclosure, however, is to provide examples of the various features and concepts related to the invention, not to limit the scope of the invention. One skilled in the relevant art will recognize that numerous variations and modifications may be made to the example structures described above without departing from the scope of the present invention. For example, the features discussed above for improving dumping of the load from the truck body can be provided on their own or in combination with one or more of the other features as desired.

1. A truck body for a mining dump truck comprising a floor, a pair of side walls, and a front wall connected to the floor and the side walls defining a payload bed for accepting material, and a front transition surface between the front wall and the floor along at least 50% of the width extending between the side walls, the front transition surface being curved with a radius of curvature of at least 500 mm.

2. A truck body in accordance with claim 1 having a corner transition surface between the front wall and each of the side walls along at least 50% of their heights, with each said corner transition surface being curved with a radius of curvature of at least 300 mm.

3. A truck body in accordance with claim 2 having a side transition surface between the floor and each of the side walls along at least 50% of their lengths, with each said side transition surface being curved with a radius of curvature of at least 300 mm.

4. A truck body in accordance with claim 3 wherein the floor includes a front floor portion and a rear floor portion that gradually rises upward to a position above a front floor reference line that is aligned with and extends rearward of the front floor portion.

5. A truck body in accordance with claim 4 wherein the rear floor portion is along or above a rear floor reference line that is inclined upward relative to the front floor reference line at an angle of at least ten degrees where the rear floor reference line intersects the front floor reference line at a location that is about nine tenths of the truck body length from a front end of the truck body.

6. A truck body in accordance with claim 4 wherein the front wall is curved along at least 50% of its height with a concavity in the payload bed.

7. A truck body in accordance with claim 6 wherein the curved front wall has a radius of curvature of at least 2500 mm about a horizontal axis rearward of the front wall.

8. A truck body in accordance with claim 6 wherein the side walls diverge from each other as they extend away from the floor.

9. A truck body in accordance with claim 8 wherein the side walls diverge from each other in a vertical direction at an included angle of one to twenty degrees.

10. A truck body in accordance with claim 8 wherein the side walls diverge from each other as they extend away from the front wall.

11. A truck body in accordance with claim 10 wherein the side walls diverge from each other in an axial direction at an included angle of one to six degrees.

12. A truck body in accordance with claim 1 having a side transition surface between the floor and each of the side walls along at least 50% of their lengths, with each said side transition surface being curved with a radius of curvature of at least 300 mm.

13. A truck body in accordance with claim 1 wherein the floor includes a front floor portion and a rear floor portion that gradually rises upward to a position above a front floor reference line that is aligned with and extends rearward of the front floor portion.

14. A truck body in accordance with claim 1 wherein the front wall is curved along at least 50% of its height with a concavity in the payload bed.

15. A truck body in accordance with claim 1 wherein the side walls diverge from each other as they extend away from the floor.

16. A truck body in accordance with claim 1 wherein the side walls diverge from each other at they extend away from the front wall.

17. A truck body for a mining dump truck comprising a floor, a pair of side walls, and a front wall connected to the floor and the side walls defining a payload bed for accepting material, and a corner transition surface between the front wall and each of the side walls along at least 50% of their heights, with each said corner transition surface being curved with a radius of curvature of at least 300 mm.

18. A truck body for a mining dump truck comprising a floor, a pair of side walls, and a front wall connected to the floor and the side walls defining a payload bed for accepting material, and a side transition surface between the floor and each of the side walls along at least 50% of their lengths, with each said side transition surface being curved with a radius of curvature of at least 300 mm.

19. A truck body for a mining dump truck comprising a floor, a pair of side walls, and a front wall connected to the floor and the side walls defining a payload bed for accepting material, wherein the front wall is curved along at least 50% of its height with a concavity in the payload bed having a radius of curvature of at least 2500 mm about a horizontal axis rearward of the front wall.

20. A truck body for a mining dump truck comprising a floor, a pair of side walls, and a front wall connected to the floor and the side walls defining a payload bed for accepting material, and a front transition surface between the front wall and the floor along at least 50% of the width extending between the side walls, a corner transition surface between the front wall and each of the side walls along at least 50% of their heights, and a side transition between the floor and each of the side walls along at least 50% of their lengths, wherein each of the transition surfaces extends along or outside of a diagonal reference line extending between the respective adjacent surfaces at the same angle and spaced at its midpoint at least 120 mm from the intersection of the extension of the adjacent walls.

21. A truck body for a mining dump truck comprising a floor, a pair of side walls, and a front wall connected to the floor and the side walls defining a payload bed for accepting material, and a front transition surface between the front wall and the floor along at least 50% of the width extending between the side walls, the front transition surface being along or outside of a space defined by the front wall, the floor and a diagonal line equiangular to the front wall and the floor with a midpoint 120 millimeters from the intersection of the plane of the floor and the plane of the front wall.

22. A truck body for a mining clump truck comprising a floor, a pair of side walls, and a front wall connected to the floor and the side walls defining a payload bed for accepting material, and a corner transition surface between the front wall and each of the side walls along at least 50% of their heights, each said corner transition surface being along or outside of a space defined by the front wall, the respective side wall, and a diagonal line equiangular to the front wall and the respective side wall with a midpoint 120 millimeters from the intersection of the plane of the front wall and the plane of the respective side wall.

23. A truck body for a mining dump truck comprising a floor, a pair of side walls, and a front wall connected to the floor and the side walls defining a payload bed for accepting material, and a side transition surface between the floor and each of the side walls along at least 50% of their lengths, each said side transition surface being along or outside of a space defined by the floor, the respective side wall, and a diagonal line equiangular to the floor and the respective side wall with a midpoint 120 millimeters from the intersection of the plane of the floor and the plane of the respective side wall.

24. A truck body for a mining dump truck comprising a floor, a pair of side walls, and a front wall connected to the floor and the side walls defining a payload bed for accepting material, and a curved transition between at least one of (i) the front wall and the floor, (ii) the front wall and each of the side walls, and (iii) the floor and each of the side walls, wherein at least one of the curved transitions partially defines a duct for diesel exhaust to warm a portion of the truck body.
